(19) United States
(12) Patent Application Publication
(10) Pub. No.: US 2004/0158648 A1
(43) Pub. Date: Aug. 12, 2004

(54) Network card device for LAN and WLAN systems

(76) Inventor: Mark Tung, Hsin Chuang City (TW)

Correspondence Address: Mark TUNG, P.O. Box 4-67, Hsin Chuang, Taipei, 242, TW

(21) Appl. No.: 10/365,969

(22) Filed: Feb. 10, 2003

(51) Int. Cl. G06F 15/16

(52) U.S. Cl. 709/250

(57) ABSTRACT

A network card device includes an LAN device for coupling to LAN systems, a wireless transmitting device for coupling to WLAN systems, a control device coupled between the LAN device and the wireless transmitting device to selectively communicate with the LAN systems and the WLAN systems, and a card bus coupled to the control device, to couple the control device to users or computer facilities, for allowing the users or computer facilities to selectively communicate with the LAN systems and the WLAN systems. A wireless network card member or a blue tooth transmitting interface card member may be coupled to the wireless transmitting device.

### BACKGROUND OF THE INVENTION

1. Field of the Invention

The present invention relates to a network card device, and more particularly to a network card device for selectively communicating with local area network (LAN) system and/or wireless local area network (WLAN) system.

2. Description of the Prior Art

Various kinds of typical network card devices have been developed to be coupled to computer facilities, for allowing the computer facilities to be communicated with various internet or local area network (LAN) systems via asymmetric digital subscriber line (ADSL) modulator-demodulators or modems, and/or ethernet devices. However, the typical network card devices may not be used for communicating with various wireless local area network (WLAN) systems.

For allowing the computer facilities to be communicated with various WLAN systems, an additional universal serial bus (USB) and/or a peripheral component interconnect (PCI) bus is required to be purchased and coupled to the computer facilities. The computer facilities may then be communicated with various WLAN systems via the USBs, the PCI buses, the ADSL modems, and the ethernet devices, in addition to the typical network card devices. However, the USBs and the PCI buses are expensive, and may occupy additional coupling slots of the computer facilities. In addition, the typical network card devices may be used for communicating with various LAN systems only, and may not be used for communicating with various WLAN systems directly or simultaneously.

The present invention has arisen to mitigate and/or obviate the afore-described disadvantages of the conventional network card devices.

### SUMMARY OF THE INVENTION

The primary objective of the present invention is to provide a network card device for selectively communicating with local area network (LAN) system and/or wireless local area network (WLAN) system or the blue tooth transmitting network systems.

In accordance with one aspect of the invention, there is provided a network card device comprising an LAN device for coupling to LAN systems, a wireless transmitting device for coupling to WLAN systems, a control device coupled between the LAN device and the wireless transmitting device for receiving and identifying or checking and processing the package information or network signals between the LAN device and the wireless transmitting device, to selectively communicate with the LAN systems and the WLAN systems, and a card bus coupled to the control device, to couple the control device to users or computer facilities, for allowing the users or computer facilities to selectively communicate with the LAN systems and the WLAN systems, or for allowing the users or computer facilities and the LAN systems and the WLAN systems to be selectively communicated with each other.

An LAN coupler may further be provided and coupled to the LAN device, to couple the LAN device to the LAN systems.

An antenna device may further be provided and coupled to the wireless transmitting device, to couple the control device to the WLAN systems via the wireless transmitting device.

A wireless network card member may further be provided and coupled to the wireless transmitting device, to couple to the WLAN systems via the wireless transmitting device.

A blue tooth transmitting interface card member may further be provided and coupled to the wireless transmitting device, to couple to blue tooth transmitting network systems via the wireless transmitting device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a network card device in accordance with the present invention;

FIG. 2 is a plan schematic view similar to FIG. 1, illustrating the communication of the network card device to or with the LAN system;

FIG. 3 is a block diagram illustrating the communication of the network card device to or with the LAN system as shown in FIG. 2;

FIG. 4 is a plan schematic view similar to FIGS. 1 and 2, illustrating the communication of the network card device to or with the WLAN system;

FIG. 5 is a block diagram illustrating the communication of the network card device to or with the WLAN system as shown in FIG. 4;

FIG. 6 is a plan schematic view similar to FIGS. 1, 2 and 4, illustrating the communication of the network card device to or with the LAN system and the WLAN system;

FIG. 7 is a block diagram illustrating the communication of the network card device to or with the LAN system and the WLAN system;

FIG. 8 is a plan schematic view similar to FIGS. 1, 2, 4 and 6, illustrating the communication of the network card device to or with the blue tooth transmitting network system; and

FIG. 9 is a block diagram illustrating the communication of the network card device to or with the blue tooth transmitting network system.

### DETAILED DESCRIPTION OF THE PREFERRED EMBODIMENT

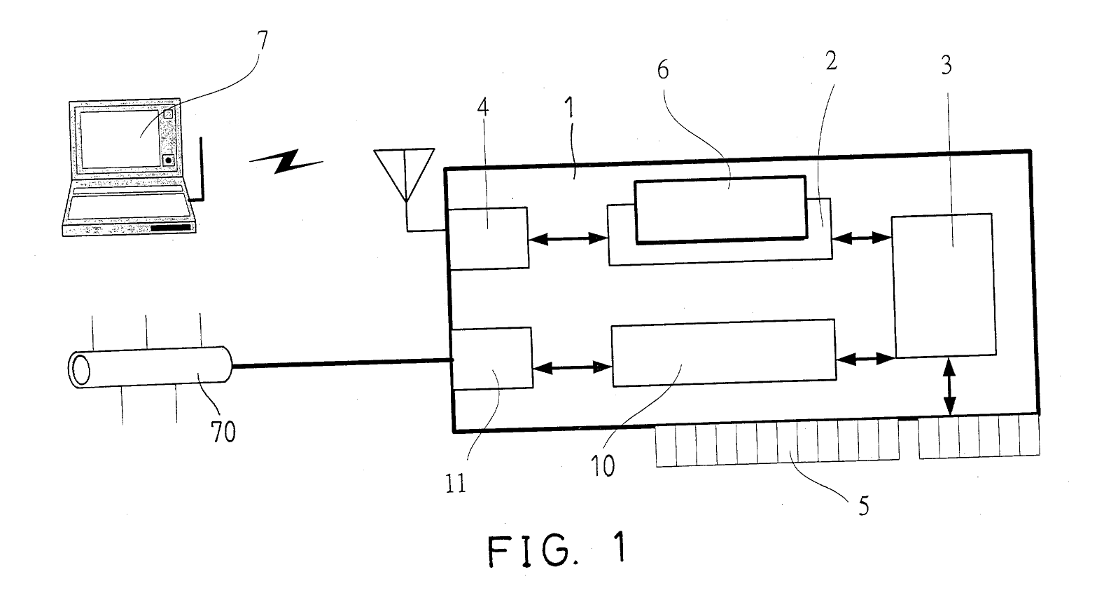

Referring to the drawings, and initially to FIG. 1, a network card device 1 in accordance with the present invention comprises a local area network (LAN) chip or device 10, a control circuit or device 3 coupled to the LAN device 10, and an LAN coupler 11 coupled to the LAN device 10, for coupling the LAN device 10 to various LAN systems 70, and for allowing package information or network signals to be transmitted or communicated between the control device 3 and the LAN systems 70 via the LAN device 10.

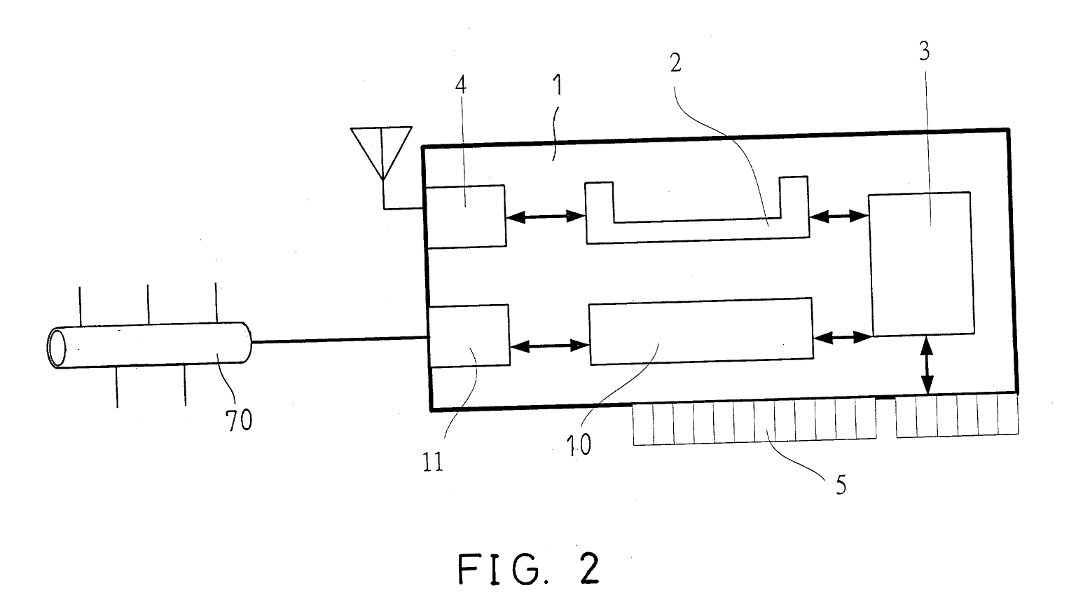

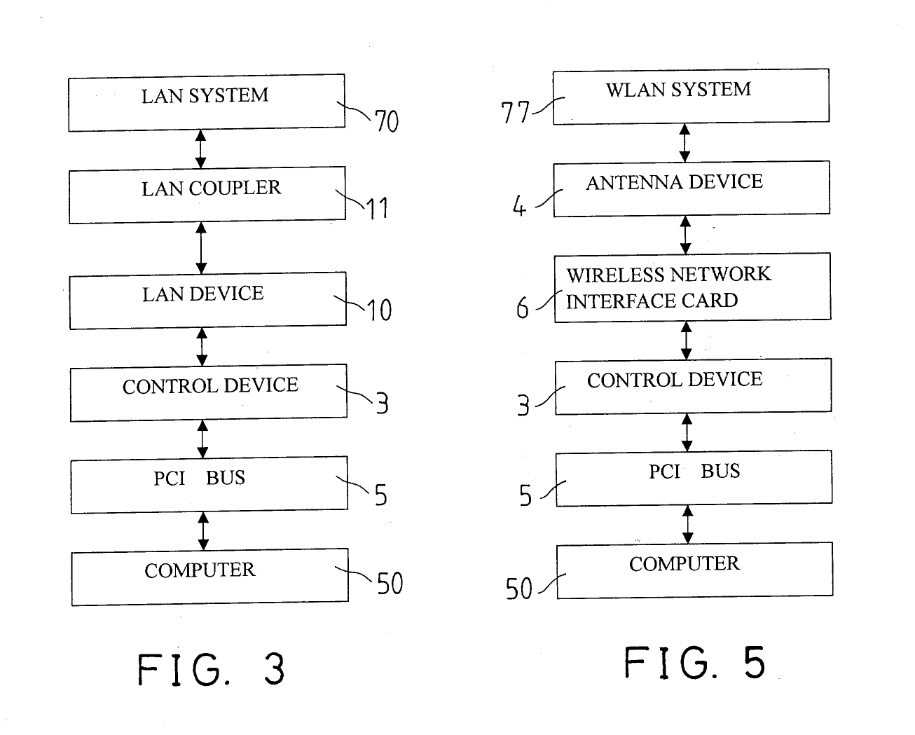

The network card device 1 includes a card bus 5, such as a peripheral component interconnect (PCI) bus 5 coupled to the control device 3, for coupling to various computers or computer facilities 50 (FIGS. 3, 5, 7, 9). In operation, as shown in FIGS. 2 and 3, the computers or computer facilities 50 may thus be transmitted or communicated with the LAN systems 70 via the PCI bus 5 and the control device 3 and the LAN device 10.

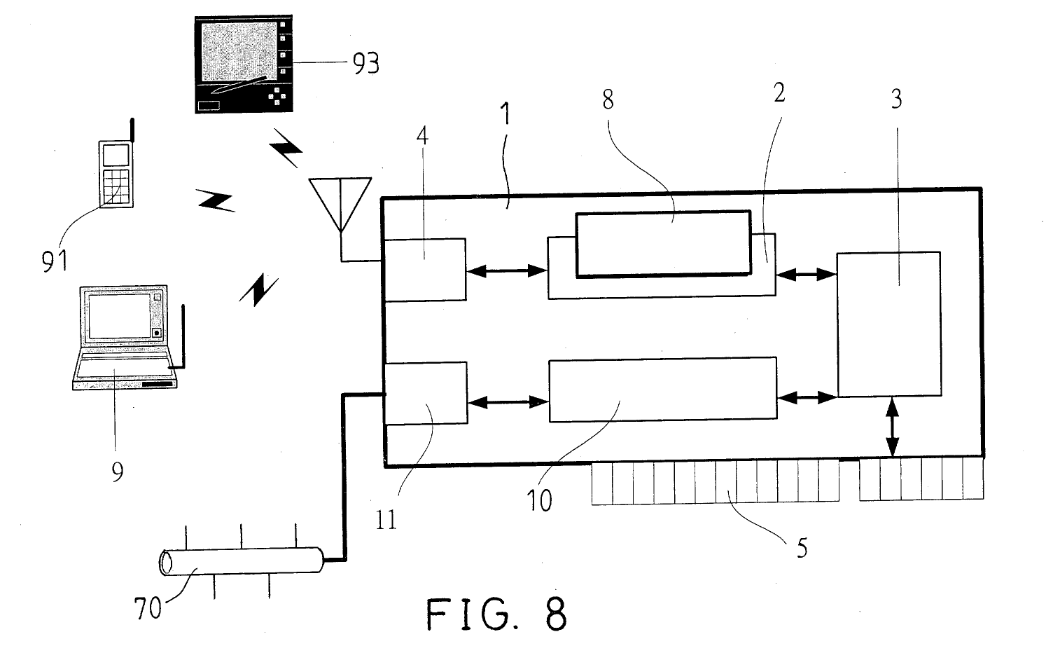

Referring again to FIG. 1, the network card device 1 further includes a wireless transmitting module or device 2 coupled to the control device 3, an antenna device 4 coupled to the wireless transmitting device 2, and a wireless network card member 6, such as a mini PCI interface card, a personal computer memory card international association (PCMCIA) card, a card bus, a blue tooth transmitting interface card member 8 (FIGS. 8, 9), or the like, to be selectively or optionally coupled or plugged to the wireless transmitting device 2.

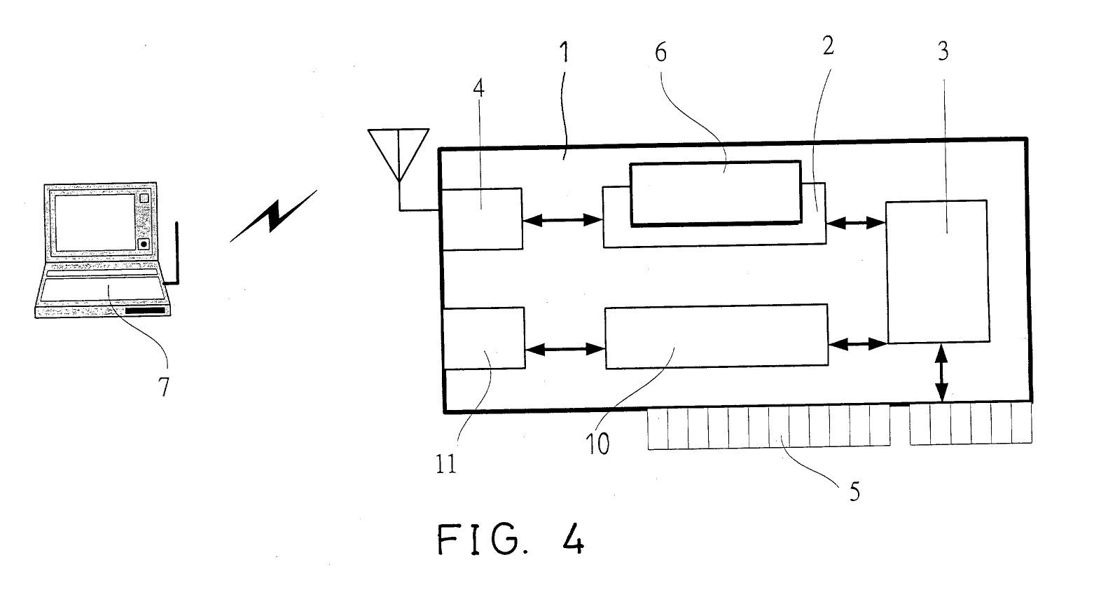

In operation, as shown in FIGS. 4 and 5, the computers or computer facilities 50 may thus be transmitted or communicated with various WLAN systems 77 (FIG. 5) via the PCI bus 5 and the control device 3 and the wireless transmitting device 2 or the wireless network card member 6 and the antenna device 4, and thus for allowing the users or the computers or computer facilities 50 to be communicated with the other end users 7 via the WLAN systems 77.

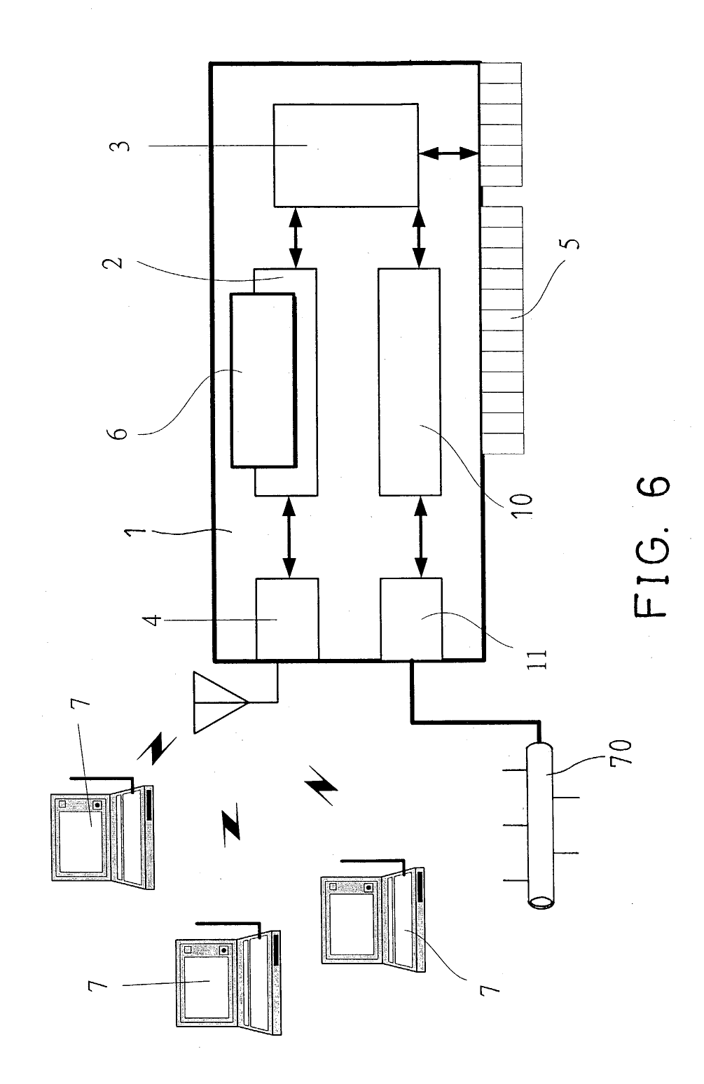

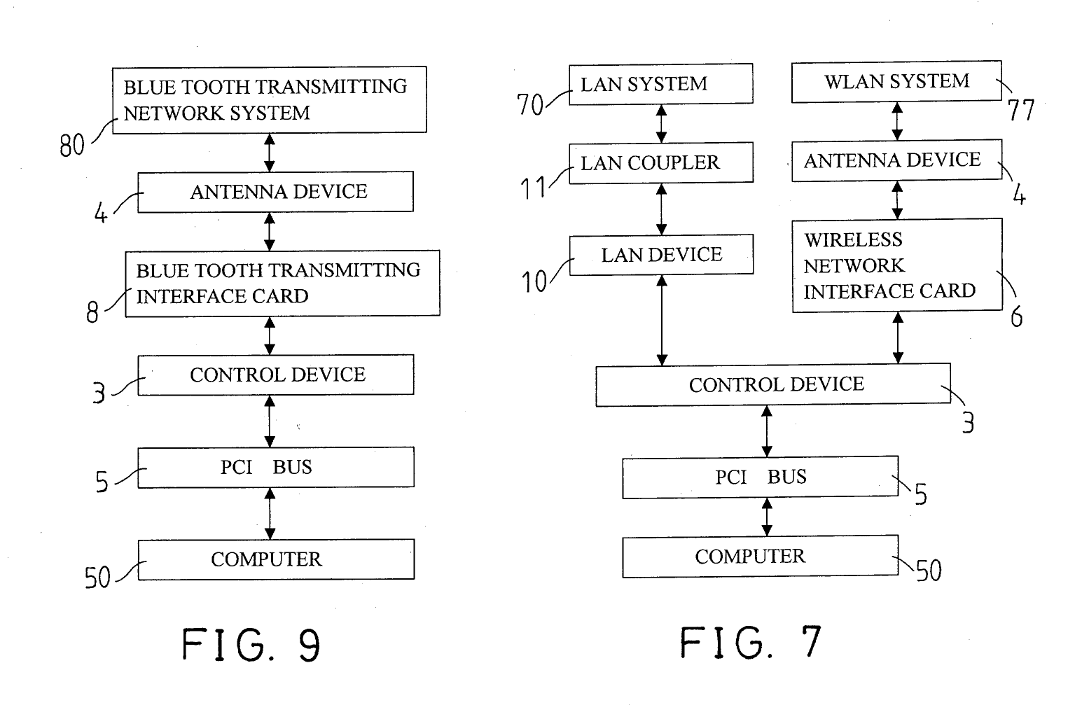

Referring next to FIGS. 6 and 7, the computers or computer facilities 50 may be transmitted or communicated with either or both the LAN systems 70 and the WLAN systems 77 via the control device 3 and the LAN device 10; and the wireless transmitting device 2 or the wireless network card member 6 and the antenna device 4, and thus for allowing the users or the computers or computer facilities 50 and the LAN systems 70 and the WLAN systems 77 to be communicated with each other selectively or simultaneously.

Referring next to FIGS. 8 and 9, instead of the wireless network card member 6, a blue tooth transmitting interface card member 8 may further be provided and selectively or optionally coupled or plugged to the wireless transmitting device 2. The users or the computers or computer facilities 50 may thus be transmitted or communicated with various blue tooth transmitting network systems 80 (FIG. 9) via the control device 3 and the wireless transmitting device 2 or the blue tooth transmitting interface card member 8 and the antenna device 4, and thus for allowing the users or the computers or computer facilities 50 to be communicated with the other end users 9, 91, 93 via the blue tooth transmitting network systems 80.

For example, the end users 9, 91, 93 may be the notebook computers 9, the portable or mobile phones 91, or the personal digital assistant (PDA) devices 93 that include one or more blue tooth chips or devices (not shown) coupled thereto or built therein, for allowing the end users 9, 91, 93 to be transmitted or communicated with the blue tooth transmitting network systems 80.

The control device 3 is provided for receiving and identifying or checking and processing the package information or network signals between the WLAN systems 77 and the LAN systems 70 or the end users 7 and the computers or computer facilities 50 or the blue tooth transmitting network systems 80, for allowing the WLAN systems 77 and the LAN systems 70 or the end users 7 and the computers or computer facilities 50 or the blue tooth transmitting network systems 80 to be transmitted or communicated with each other.

Accordingly, the network card device in accordance with the present invention may be used for selectively communicating with the local area network (LAN) systems and/or the wireless local area network (WLAN) systems or the blue tooth transmitting network systems.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A network card device comprising:
an LAN device for coupling to LAN systems,
a wireless transmitting device for coupling to WLAN systems,
a control device coupled between said LAN device and said wireless transmitting device, to selectively communicate with the LAN systems and the WLAN systems, and
a card bus coupled to said control device, to couple said control device to computer facilities, for allowing the computer facilities to selectively communicate with the LAN systems and the WLAN systems.

2. The network card device as claimed in claim 1 further comprising an LAN coupler coupled to said LAN device, to couple said LAN device to the LAN systems.

3. The network card device as claimed in claim 1 further comprising an antenna device coupled to said wireless transmitting device, to couple said control device to the WLAN systems via said wireless transmitting device.

4. The network card device as claimed in claim 1 further comprising a wireless network card member coupled to said wireless transmitting device, to couple to the WLAN systems via said wireless transmitting device.

5. The network card device as claimed in claim 1 further comprising a blue tooth transmitting interface card member coupled to said wireless transmitting device, to couple to blue tooth transmitting network systems via said wireless transmitting device.
